(19) United States
(12) Patent Application Publication
(10) Pub. No.: US 2014/0238568 A1
(43) Pub. Date: Aug. 28, 2014

(54) PNEUMATIC TIRE FOR HEAVY LOAD

(71) Applicant: Takafumi Haga, Kodaira-shi (JP)

(72) Inventor: Takafumi Haga, Kodaira-shi (JP)

(73) Assignee: BRIDGESTONE CORPORATION, Chuo-ku, Tokyo (JP)

(21) Appl. No.: 14/349,266

(22) PCT Filed: Oct. 3, 2011
(86) PCT No.: PCT/JP2011/005583

§ 371 Date: Apr. 2, 2014

(51) Int. Cl. B60C 11/03

(52) U.S. Cl. CPC B60C 11/0309; B60C 2011/0348; B60C 2011/0386; B60C 2011/0346
USPC 152/209.18

(57) ABSTRACT

An object of the present invention is to provide a tire for heavy load, which exhibits good performances in both fuel efficiency and drainage. One example of the pneumatic tire comprising a tread portion and a pair of circumferential main grooves formed in a ground contact surface of the tread portion to section the ground contact surface of the tread portion into the central region and respective side regions, wherein the tire further comprises three circumferential narrow grooves formed in the central region to demarcate four rib-like center land portions in the central region; and the central region has a structure in which openings of the circumferential narrow grooves are closed so that the rib-like center land portions adjacent to each other with the circumferential narrow grooves therebetween are in contact with and thus supported by each other when the tire is in contact with the ground.

### TECHNICAL FIELD

The present invention relates to a tire for use in a heavy-load vehicle such as a truck, a bus and the like, which tire exhibits good performances in both fuel efficiency and drainage.

### BACKGROUND ART

General examples of a pneumatic tire for heavy load for use in a heavy-load vehicle such as a truck, a bus and the like include: a what is called “rib-pattern” tire, in which plural circumferential grooves extending in the tire circumferential direction are formed in a ground contact surface of a tread to demarcate a plurality of rib-like land portions in the tread, as shown in FIG. 8; and a what is called “block-pattern” tire, in which plural circumferential grooves extending in the tire circumferential direction and plural width direction grooves extending in the tire width direction are formed in a ground contact surface of a tread to demarcate a plurality of block land portions in the tread.

With regard to a tire having a rib-pattern, the tire has a relatively short total length of grooves and open-end sipes formed therein, i.e. relatively few edge components existing in a ground contact surface of the tire, whereby not so much improvement of drainage performance by an edge effect can be expected in the tire. However, it is still possible to ensure satisfactory drainage performance of the tire by, for example, increasing groove widths of the circumferential main grooves thereof. On the other hand, the rib-pattern tire has a problem in that it cannot satisfactorily reduce rolling resistance affecting fuel efficiency, after all, because the rib-like land portions demarcated by wide circumferential main grooves exhibit relatively large magnitudes of deformation when a force is inputted in the tire width direction in a cornering situation or the like, although the rib-like land portions extending integrally and continuously in the circumferential direction exhibit relatively high rigidity against a force inputted in the circumferential direction in a driving/braking situation and can suppress magnitudes of deformation thereof in the circumferential direction relatively well.

PTL1, for example, discloses as a rib-patterned tire attempting to improve drainage performance and reduce rolling resistance simultaneously a pneumatic tire having a tread pattern in which: rib-like land portions are demarcated into block-like land portions by further provision, in each rib-like land portion, of plural tire width direction fine grooves extending in the tire width direction across the rib-like land portion and having groove width of 0.5 to 1.5 mm; and a closed sipe is formed in each block-like land portion such that the sipe extends to be inclined in the opposite direction to the tire width direction fine grooves with respect to the tire axial direction.

The pneumatic tire of PTL1 attempts to improve drainage performance thereof by providing each rib-like land portion with the tire width direction fine grooves and the closed sipes, instead of increasing the groove width of the circumferential main grooves, such that the edge components existing in a ground contact surface of the tire are effectively increased. However, the rib-like land portions are demarcated into the block-like land portions by provision of the tire width direction fine grooves, i.e. the respective block-like land portions are substantially divided by the tire width direction fine grooves in the tire of PTL1, whereby rigidity of the land portions against a force inputted in the tire width direction decreases and thus magnitudes of deformation in the tire width direction of the bloke-like land portions increase in the tire. PTL1 therefore cannot cause an effect of reducing rolling resistance in a satisfactory manner, thus leaving room for further improvement.

With regard to a tire having a block-pattern, the tire is advantageous in terms of drainage performance because respective block land portions are demarcated by circumferential main grooves and width direction main grooves and there exist ample edge components in a ground contact surface of the tire. However, the tire has a problem in that it exhibits relatively high rolling resistance because the block-like land portions thereof adjacent to each other with the circumferential main grooves and the width direction main grooves therebetween fail to be brought into contact with each other when these land portions are in contact with the ground, whereby rigidity of the tread land portion fully depends on respective rigidities of the individual block land portions, which are each relatively small, and magnitudes of deformation of the land portions become significantly high after all.

### CITATION LIST

### Patent Literature

PTL 1: JP 2000-177333 Laid-Open

### SUMMARY OF THE INVENTION

### Technical Problems

An object of the present invention is to provide a tire for use in a heavy load vehicle such as a truck, a bus and the like, which tire exhibits good performances in both fuel efficiency and drainage by appropriate demarcation of land portions located in the central region of a ground contact surface of a tread portion of the tire by various types of narrow (fine) grooves.

### Solution to the Problems

In order to achieve the aforementioned object, the present invention provides a pneumatic tire for heavy load, at least comprising a tread portion and a pair of circumferential main grooves formed in a ground contact surface of the tread portion to extend along the tire circumferential direction with the tire equatorial plane therebetween and section the ground contact surface of the tread portion into the central region and respective side regions, wherein

the tire further comprises at least one circumferential narrow groove formed in the central region to extend along the tire circumferential direction and demarcate at least two rib-like center land portions in the central region; and

the central region has a structure in which an opening of the circumferential narrow groove is closed so that the rib-like center land portions adjacent to each other with the circumferential narrow groove therebetween are in contact with and thus supported by each other when the tire is in contact with the ground.

Further, in the present invention, it is preferable that each rib-like center land portion is provided with a plurality of tire width direction fine grooves extending in the tire width direction across the rib-like center land portion to demarcate block-like center land portions in the rib-like center land portion, and

the central region has a structure in which openings of the circumferential narrow groove and the tire width direction fine grooves are closed such that the block-like center land portions adjacent to each other are in contact with and thus supported by each other when the tire is in contact with the ground.

Yet further, it is preferable in the present invention that groove widths of the tire width direction fine grooves and the circumferential narrow groove are each equal to or smaller than 3 mm, respectively.

Yet further, it is preferable in the present invention that: each side region is provided with a plurality of tire width direction main grooves extending in the tire width direction across the side region to demarcate plural block-like side land portions in the side region; and each of the tire width direction main grooves has a bottom-raised portion therein connecting the block-like side land portions adjacent to each other with the tire width direction main groove therebetween. The bottom-raised portion of each tire width direction main groove has a length in the longitudinal direction thereof preferably 0.3-0.8 times as much as the width or longitudinal length of the block-like side land portion and a height preferably 0.5-0.8 as much as the groove depth of the tire width direction main groove.

### Advantageous Effect of the Invention

According to the present invention, it is possible to provide a tire for use in a heavy load vehicle such as a truck, a bus and the like, which tire exhibits good performances in both fuel efficiency and drainage by appropriately demarcation of land portions located in the central region of a ground contact surface of a tread portion of the tire by various types of narrow (fine) grooves.

### BRIEF DESCRIPTION OF THE DRAWINGS

FIG. 1 is a developed view of a part of a tread portion of a pneumatic radial tire for heavy load according to one embodiment of the present invention.

FIG. 2 is a developed view of a part of a tread portion of a pneumatic radial tire for heavy load according to another embodiment of the present invention.

FIG. 3 is a developed view of a part of a tread portion of a pneumatic radial tire for heavy load according to yet another embodiment of the present invention.

FIG. 4 is a developed view of a part of a tread portion of a pneumatic radial tire for heavy load according to yet another embodiment of the present invention.

FIG. 5 is a developed view of a part of a tread portion of a pneumatic radial tire for heavy load according to yet another embodiment of the present invention.

FIG. 6 is a developed view of a part of a tread portion of a pneumatic radial tire for heavy load according to yet another embodiment of the present invention.

FIG. 7 is a developed view of a part of a tread portion of a pneumatic radial tire for heavy load according to yet another embodiment of the present invention.

FIG. 8 is a developed view of a part of a tread portion of the conventional pneumatic radial tire for heavy load.

### DESCRIPTION OF THE EMBODIMENTS

Next, an embodiment of the present invention will be described hereinafter with reference to the drawings.

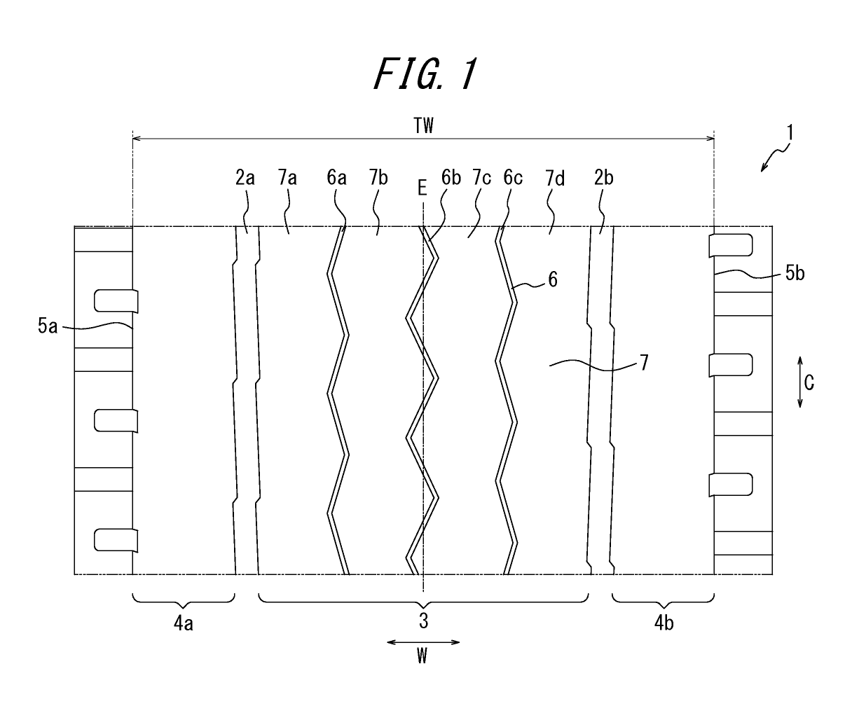

FIG. 1 shows a part of a tread portion (a tread pattern) of a pneumatic tire for heavy load according to one embodiment of the present invention.

The pneumatic tire for heavy load having a tread portion 1 includes a pair of circumferential main grooves 2a, 2b formed in a ground contact surface of the tread portion 1 to extend along the tire circumferential direction C with the tire equatorial plane E therebetween, as shown in FIG. 1. The pair of circumferential main grooves 2a, 2b are provided so as to section the ground contact surface of the tread portion 1 into the central region 3 and respective side regions 4a, 4b.

In the present invention, the “central region” represents a region, of a ground contact surface of the tread portion, having the center aligned with the tire equatorial plane E and a width corresponding to 40% to 65% of the tread width TW; and each “side region” represents a region, of a ground contact surface of the tread portion, located on the outer side in the tire width direction of the central region 3 with the corresponding circumferential main groove 2a, 2b between the side region and the central region 3, i.e. a region defined by the circumferential main groove 2a/2b and a corresponding tread end 5a/5b.

The primary structural feature of the present invention resides in appropriate demarcation of land portions located in the central region 3 of a ground contact surface of the tread portion of the tire by various types of narrow (fine) grooves. Specifically, at least one circumferential narrow groove 6 (three circumferential narrow grooves 6a, 6b, 6c in FIG. 1) is formed in the central region 3 to extend along the tire circumferential direction C and demarcate at least two rib-like center land portions 7 (four rib-like center land portions 7a, 7b, 7c, 7d in FIG. 1) in the central region 3; and the central region 3 has a structure in which openings of the circumferential narrow grooves 6a, 6b, 6c are closed so that (facing walls of) the two rib-like center land portions 7a;7b, 7b;7c, 7c;7d adjacent to each other with the corresponding circumferential narrow groove 6a, 6b, 6c therebetween are in contact with and thus supported by each other when the tire is in contact with the ground. Both of fuel efficiency performance and drainage performance of the tire can be significantly improved by adopting the aforementioned structures.

More specifically, good drainage properties are ensured in the present invention by providing a pair of the relatively wide circumferential main grooves 2a, 2b so as to section a ground contact portion of the tread portion 1 into the central region 3 and the side regions 4a, 4b. Further, at least one circumferential narrow groove 6a, 6b, 6c having a relatively narrow width is formed in the central region 3 to extend along the tire circumferential direction C and demarcate at least two rib-like center land portions 7a, 7b, 7c, 7d in the central region 3, so that the central region 3 has a structure in which openings of the circumferential narrow grooves 6a, 6b, 6c are closed and thus the rib-like center land portions 7a, 7b, 7c, 7d adjacent to each other with the corresponding circumferential narrow groove 6a, 6b, 6c therebetween are in contact with and supported by each other when the tire is in contact with the ground. As a result, the respective adjacent rib-like center land portions 7a;7b, 7b;7c, 7c;7d located in the central region 3 can collectively resist a force inputted in the tire width direction W, as well as a force inputted in the tire circumferential direction C, when the tire is in contact with the ground. In other words, in whichever direction a force is inputted on the tire, magnitudes of deformation of the land portions 7a to 7d located in the central region 3 can be effectively suppressed and rolling resistance of the tire can be significantly reduced. The term “when the tire is in contact with the ground” as used herein specifically represents a condition where the tire is mounted on an application rim, inflated at a specified internal pressure, placed on a flat plate in a standstill state, and subjected to the normal load vertically applied thereto. The term “application rim” as used herein refers to a “standard rim” specified under JATMA, “Design Rim” specified under TRA or “Measuring Rim” specified under ETRTO. The term “specified internal pressure” as used herein refers to “an air pressure corresponding to the maximum load capability” specified under JATMA, the maximum value of “TIRE LOAD LIMITS AT VARIOUS COLD INFLATION PRESSURES” specified under TRA or “INFLATION PRESSURES” specified under ETRTO. The term “normal load” as used herein refers to a “maximum load capability” specified under JATMA, the maximum value of “TIRE LOAD LIMITS AT VARIOUS COLD INFLATION PRESSURES” specified under TRA or “LOAD CAPACITY” specified under ETRTO.

The groove width of the circumferential main groove 2a, 2b is preferably at least 5 mm in terms of ensuring good drainage properties. The groove width of the circumferential main groove 2a, 2b larger than 30 mm, however, results in too low area proportion of the tread land portions located within a ground contact surface of the tire, i.e. too large negative ratio in the ground contact surface, thereby facilitating deterioration of wear resistance. Accordingly, the upper limit of the groove width of the circumferential main groove 2a, 2b is preferably 30 mm.

A configuration of the circumferential main groove 2a, 2b in the extending direction thereof is preferably a zigzag-shape or a wavy shape as shown in FIG. 1 in terms of increasing edge components in the tire width direction to improve driving performance, braking performance and drainage performance of the tire. However, the configuration of the circumferential main groove 2a, 2b in the extending direction thereof may be linear. Further, the respective circumferential main grooves 2a, 2b do not need to share exactly the same zigzag configuration. One circumferential main groove 2a may be shifted from the other circumferential main groove 2b by a half pitch; and/or the circumferential main grooves 2a, 2b may have amplifications and wavelengths different from each other.

The groove width of the circumferential narrow groove 6a, 6b, 6c is preferably ≦3 mm in terms of ensuring that an opening of the groove closes when the tire is in contact with the ground (when the tire is rotated with lord exerted thereon) to curb rolling resistance of the tire. The groove width of the circumferential narrow groove 6a, 6b, 6c smaller than 0.5 mm, however, causes no effect of improving drainage properties, as compared with rib-like land portions lacking the circumferential narrow grooves. Accordingly, the lower limit of the groove width of the circumferential narrow groove 6a, 6b, 6c is preferably 0.5 mm.

A configuration of the circumferential narrow groove 6a, 6b, 6c in the extending direction thereof is preferably a zigzag-shape or a wavy shape as shown in FIG. 1 in terms of increasing edge components in the tire width direction to improve driving performance, braking performance and drainage performance of the tire. However, the configuration of the circumferential narrow groove 6a, 6b, 6c in the extending direction thereof may be linear. Further, the respective circumferential narrow grooves 6a, 6b, 6c do not need to share exactly the same zigzag configuration. One circumferential narrow groove may be shifted from the other circumferential narrow groove by a half pitch; and/or the circumferential narrow grooves 6a, 6b, 6c may have amplifications and wavelengths different from each other.

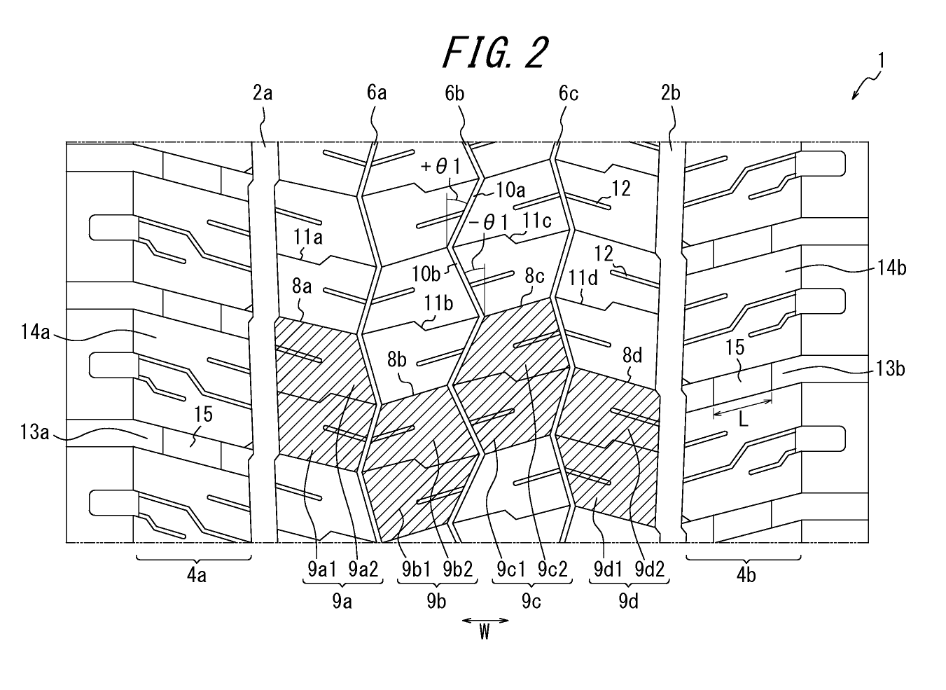

In a case where the circumferential narrow groove 6a, 6b, 6c has a zigzag configuration in the extending direction thereof, the circumferential narrow groove 6a, 6b, 6c is preferably constituted of two types of narrow groove portions 10a, 10b each extending at an angle of +θ1/−θ1 (|θ1|≦50°) with respect to the tire circumferential direction, i.e. each alternately extending in a different direction, as shown in FIG. 2. |θ1|>50° makes corner portions of the land portions too sharp and decreases rigidities of the corner portions, thereby possibly causing a problem of rubber chipping or the like.

Further, it is preferable in the present invention that: each rib-like center land portion 7a-7d is provided with a plurality of tire width direction fine grooves 8a, 8b, 8c, 8d extending in the tire width direction W across the rib-like center land portion to demarcate block-like center land portions 9a, 9b, 9c, 9d in the rib-like center land portion as shown in FIG. 2; and the central region 3 has a structure in which openings of the circumferential narrow grooves 6a, 6b, 6c and the tire width direction fine grooves 8a, 8b, 8c, 8d are closed such that the block-like center land portions 9a, 9b, 9c, 9d adjacent to each other with the circumferential narrow grooves 6a, 6b, 6c and the tire width direction fine grooves 8a, 8b, 8c, 8d therebetween are in contact with and thus supported by each other when the tire is in contact with the ground, in terms of effectively increasing edge components to further improve drainage performance of the tire with maintaining rigidity of the land portions located in the central region 3 and suppressing deformation of the block-like center land portions 9a, 9b, 9c, 9d. In FIG. 2, incidentally, only one block-like land portion 9a, 9b, 9c, 9d is hatched in each row of the block-like land portions 9a, 9b, 9c, 9d for convenience.

The groove width of each of the tire width direction fine grooves 8a, 8b, 8c, 8d is preferably ≦3 mm and more preferably ≦1.5 mm in terms of ensuring that openings of the grooves close when the tire is in contact with the ground (when the tire is rotated with lord exerted thereon) to curb rolling resistance of the tire. The groove width of the tire width direction fine groove 8a, 8b, 8c, 8d smaller than 0.5 mm, however, causes no effect of improving drainage properties, as compared with rib-like land portions lacking the tire width direction fine grooves. Accordingly, the lower limit of the groove width of the tire width direction fine groove 8a, 8b, 8c, 8d is preferably 0.5 mm. An angle at which the tire width direction fine groove 8a, 8b, 8c, 8d extends with respect to the tire circumferential direction is preferably in the range of 55° to 125° in terms of ensuring good rigidities of corner portions of the land portions demarcated by the tire width direction fine groove 8a, 8b, 8c, 8d to prevent rubber chipping from occurring.

Further, in the present invention, each of the block-like center land portions 9a, 9b, 9c, 9d may be provided with a tire width direction auxiliary fine groove 11a, 11b, 11c, 11d extending in a crank-like shape in the tire width direction to section the block-like center land portion into two small block land portions 9a1; 9a2, 9b1; 9b2, 9c1; 9c2, 9d1; 9d2, to further increase edge components, as shown in FIG. 2. Yet further, each of the small block land portions may be provided with a tire width direction fine sub-groove 12 extending in the tire width direction to terminate in the land portion, as shown in FIG. 2. These optional structures may be provided in an appropriate manner according to necessity.

Yet further, in the present invention, a (rib-like) land portion located in each side region 4a, 4b may be provided with a plurality of tire width direction main grooves 13a, 13b extending in the tire width direction W across the side region to demarcate plural block-like side land portions 14a, 14b in the side region, as shown in FIG. 2. Drainage performance toward side portions of the tire can be improved by provision of the tire width direction main grooves 13a, 13b. The groove width of the tire width direction main groove 13a, 13b is preferably in the range of 4 mm to 18 mm. The groove width of the tire width direction main groove 13a, 13b smaller than 3 mm cannot improve drainage performance toward side portions of the tire in a satisfactory manner. The groove width of the tire width direction main groove 13a, 13b larger than 18 mm decreases a ground contact area to deteriorate driving stability and reduces the size of each block-like side land portion 14a, 14b to decrease rigidity thereof, thereby facilitating deformation of the block-like side land portion 14a, 14b and possibly increasing rolling resistance of the tire.

It is preferable in the present invention that each of the tire width direction main grooves 13a, 13b has a bottom-raised portion 15 provided therein to connect the two block-like side land portions 14a;14a, 14b;14b adjacent to each other with the tire width direction main groove 13a, 13b therebetween. It is possible by this arrangement to effectively suppress deformation of the block-like side land portions 14a, 14b without deteriorating drainage properties thereof.

The bottom-raised portion 15 of each tire width direction main groove 13a, 13b has a length L in the longitudinal direction thereof preferably 0.3-0.8 times as much as the width or longitudinal length of the block-like side land portion 14a, 14b and a height, measured from a groove bottom position, preferably 0.5-0.8 times as much as the groove depth of the tire width direction main groove. In a case where a length L in the longitudinal direction of the bottom-raised portion 15 is shorter than (the width of the block-like side land portion 14a, 14b)×0.3, rigidities of the block-like side land portions 14a, 14b are not sufficiently high and partial wear is likely to occur therein. In a case where a length L in the longitudinal direction of the bottom-raised portion 15 exceeds (the width of the block-like side land portion 14a, 14b)×0.8, edge components will decrease at the final stage of use of the tire, thereby possibly causing significant deterioration of drainage performance toward side portions of the tire. In a case where the height of the bottom-raised portion 15 is shorter than (the groove depth of the tire width direction main groove 13a, 13b)×0.5, rigidities of the block-like side land portions 14a, 14b are not sufficiently high and partial wear is likely to occur therein. In a case where the height of the bottom-raised portion 15 exceeds (the groove depth of the tire width direction main groove 13a, 13b)×0.8, drainage performance toward side portions of the tire may not be improved in a satisfactory manner by provision of the tire width direction main groove 13a, 13b.

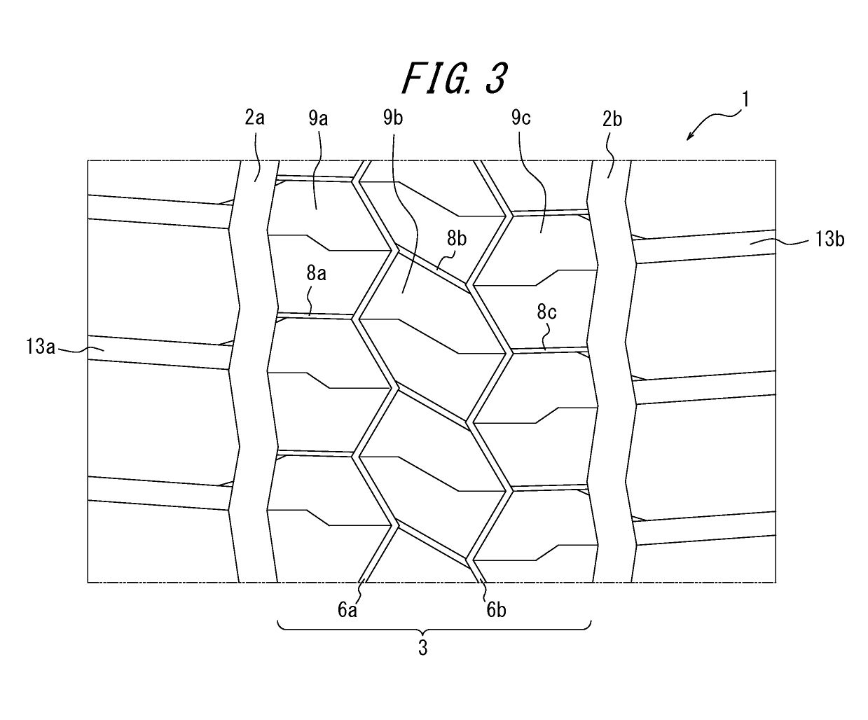

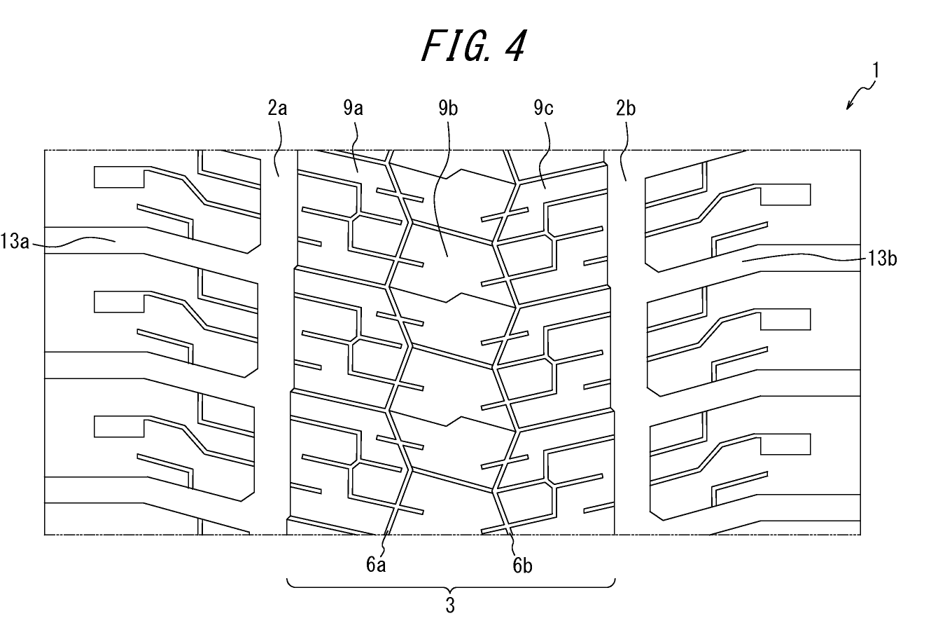

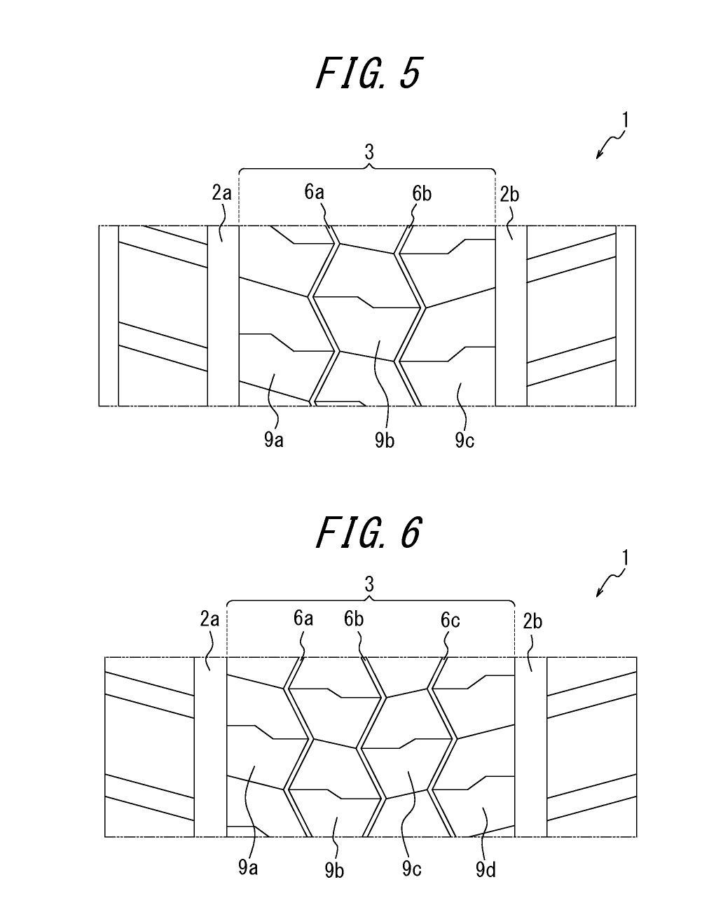

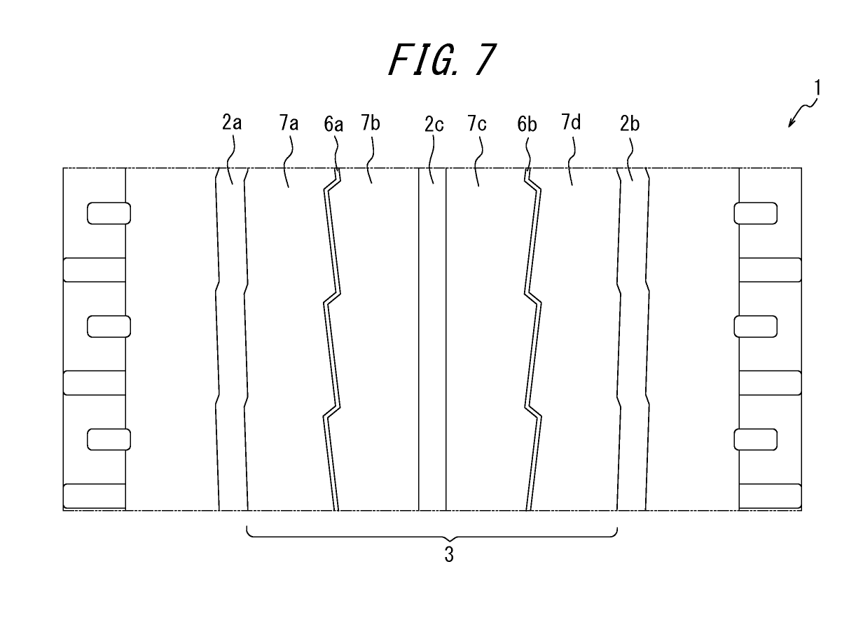

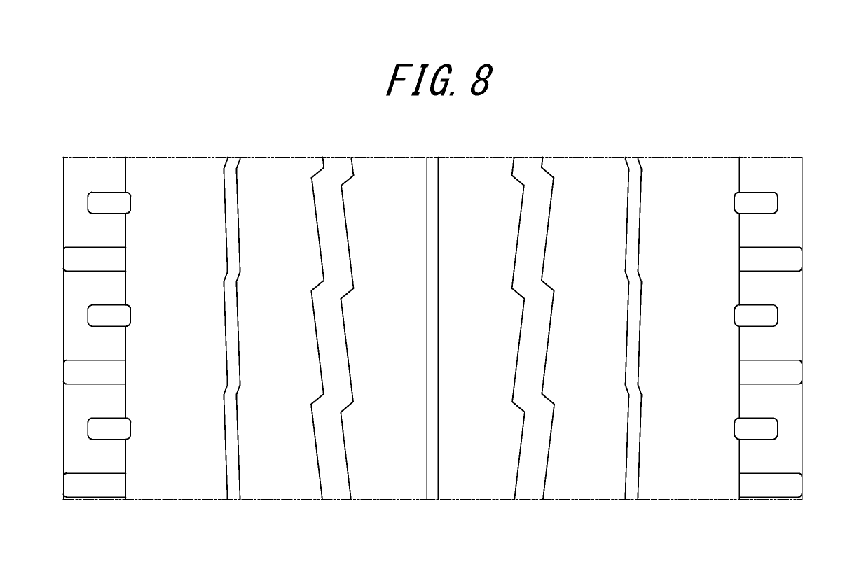

The present invention allows various other embodiments and examples thereof include: a tire in which two circumferential narrow groove 6a, 6b are formed in the central region 3 of a ground contact surface of the tread portion 1 to demarcate three rib-like land portions or block-like land portion rows in the central region 3, as shown in each of FIGS. 3 to 5; a tire in which a pair of the linear circumferential main grooves 2a, 2b is formed in a ground contact surface of the tread portion 1 to define the central region 3, and three zigzag-shaped circumferential narrow grooves 6a, 6b, 6c are formed in the central region 3 to demarcate four rib-like land portions or block-like land portion rows in the central region, as shown in FIG. 6; and a tire in which a pair of the zigzag-shaped circumferential linear main grooves 2a, 2b is formed in a ground contact surface of the tread portion 1 to define the central region 3, a linear central main groove 2c is further formed at the tire equatorial plane to section the land portion in the central region 3 into two parts, and each land portion demarcated by the circumferential main groove 2a/2b and the central main groove 2c is sectioned into two rib-like land portions 7a;7b, 7c;7d by the circumferential narrow groove 6a, 6b, as shown in FIG. 7.

The foregoing descriptions are merely some examples of embodiments of the present invention and the present invention may of course be subjected to various changes within the scope of the claims.

### EXAMPLES

Next, pneumatic test tires for heavy load according to the present invention were prepared and performances thereof were evaluated, as described below. Test tires of Examples 1 to 5 each had tire size: 315/70R22.5 and characteristics details of the structure of a tread portion as shown in Table 1. Tire structures other than the structure of the tread portion of Examples 1-5 tires were the same as those of the conventional pneumatic tire for heavy load because the unique characteristics of the present invention lie in a tread pattern. A test tire having tire size: 315/70R22.5 and a tread pattern as shown in FIG. 8 was also prepared as Conventional tire for comparison.

Table 1

TABLE 1

| | | | | Tire | | | | | |
|---|---|---|---|---|---|---|---|---|---|
| | | | | width | | | | | |
| | Circumferential | Circumferential | | direction | Tire width | | | | Block- |
| | main | narrow groove 6 | | fine | direction main | | | | like side |
| | groove 2 | | Configuration | groove 8 | groove 13 | | Bottom-raised | | land |
| | Groove | Groove | in | Groove | Groove | Groove | portion 15 | | portion |
| | width | width | extending | width | width | depth | Length | Height | Width |
| | (mm) | (mm) | direction | (mm) | (mm) | (mm) | L (mm) | L (mm) | (mm) |
| Conventional | Groove width of circumferential outer main groove: 5.2 mm, | | | | | | | | |
| Example | Groove width of circumferential middle main groove: 13.0 mm, | | | | | | | | |
| | Groove width of circumferential center main groove: 5.0 mm | | | | | | | | |
| Example 1 | 7 | 1.5 | linear | Not | Not formed | | Not formed | | 45 |
| | | | | formed | | | | | |
| Example 2 | 7 | 1.5 | linear | 0.5 | Not formed | | Not formed | | 45 |
| Example 3 | 7 | 1.5 | linear | 0.5 | 6 | 15 | Not formed | | 45 |
| Example 4 | 7 | 1.5 | linear | 0.5 | 6 | 15 | 23 | 11 | 45 |
| Example 5 | 7 | 1.5 | Zigzag- | 0.5 | 6 | 15 | 23 | 11 | 45 |
| | | | shaped | | | | | | |
| | | | θ1 = ±10° | | | | | | |

(Testing Method)

Each of the test tires was assembled with an application rim (rim size: 9.00) and fuel efficiency performance and drainage performance thereof were evaluated, respectively. Fuel efficiency performance was evaluated by: setting the test tire in a drum tester having an iron surface and diameter of 1.7 m; measuring rolling resistance on the axle under conditions including tire internal pressure: 900 kPa, load: 3187.5 kgf, and speed: 80 km/hour; and comparing the values of rolling resistance thus measured. The measurement of rolling resistance described above was in accordance with ISO18164 and carried out by Force method using a smooth drum. Drainage performance was evaluated by: running the test tire on a test course having radius of 20 m and a wet road surface of water depth: 2 mm under conditions including tire internal pressure: 900 kPa, load: 3350 kgf, and speed: 30 km/hour; and assessing drainage performance in cornering situations based on how a professional driver felt about drainage. The evaluation results are shown in Table 2. The values of fuel efficiency performance and drainage performance in Table 2 are index values relative to the corresponding values of Conventional tire being “100”, respectively. The larger values represent the better performance.

Table 2

TABLE 2

| | Fuel efficiency performance | Drainage performance |
|---|---|---|
| Conventional | 100 | 100 |
| Example | | |
| Example 1 | 120 | 100 |
| Example 2 | 120 | 105 |
| Example 3 | 110 | 110 |
| Example 4 | 115 | 110 |
| Example 5 | 117 | 120 |

It is understood from the results shown in Table 2 that Examples 1-5 tires each exhibit drainage performance at least equal to and generally better than that of Conventional tire and fuel efficiency performance significantly better than that of Conventional tire.

### INDUSTRIAL APPLICABILITY

According to the present invention, it is possible to provide a tire for use in a heavy load vehicle such as a truck, a bus and the like, which tire exhibits good performances in both fuel efficiency and drainage by appropriate demarcation of land portions located in the central region of a ground contact surface of a tread portion of the tire by various types of narrow (fine) grooves.

### REFERENCE SIGNS LIST

| | |
|---|---|
| 1 | Tread portion |
| 2, 2a, 2b | Circumferential main groove |
| 3 | Central region |
| 4a, 4b | Side region |
| 5a, 5b | Tread end |
| 6, 6a, 6b, 6c | Circumferential narrow groove |
| 7, 7a, 7b, 7c, 7d | Rib-like center land portion |
| 8, 8a, 8b, 8c, 8d | Tire width direction fine groove |
| 9, 9a, 9b, 9c, 9d | Block-like center land portion |
| 10a, 10b | Two types of narrow groove portions constituting |
| | circumferential narrow groove |
| 11a, 11b, 11c, 11d | Tire width direction auxiliary fine groove |
| 12 | Tire width direction fine sub-groove |
| 13a, 13b | Tire width direction main groove |
| 14a, 14b | Block-like side land portion |
| 15 | Bottom-raised portion |

1.-4. (canceled)

5. A pneumatic tire for heavy load, at least comprising a tread portion and a pair of circumferential main grooves formed in a ground contact surface of the tread portion to extend along the tire circumferential direction with the tire equatorial plane therebetween and section the ground contact surface of the tread portion into the central region and respective side regions, wherein:
the tire further comprises at least one circumferential narrow groove formed in the central region to extend along the tire circumferential direction and demarcate at least two rib-like center land portions in the central region; and
the central region has a structure in which an opening of the circumferential narrow groove is closed so that the rib-like center land portions adjacent to each other with the circumferential narrow groove therebetween are in contact with and thus supported by each other when the tire is in contact with the ground.

6. The pneumatic tire for heavy load of claim 5, wherein each rib-like center land portion is provided with a plurality of tire width direction fine grooves extending in the tire width direction across the rib-like center land portion to demarcate block-like center land portions in the rib-like center land portion, and
the central region has a structure in which openings of the circumferential narrow groove and the tire width direction fine grooves are closed such that the block-like center land portions adjacent to each other are in contact with and thus supported by each other when the tire is in contact with the ground.

7. The pneumatic tire for heavy load of claim 6, wherein groove widths of the tire width direction fine groves are each equal to or smaller than 3 mm.

8. The pneumatic tire for heavy load of claim 5, wherein groove width of the circumferential narrow groove is equal to or smaller than 3 mm.
